(19) United States
(12) Patent Application Publication
(10) Pub. No.: US 2026/0230493 A1
(43) Pub. Date: Aug. 6, 2026

(54) MEASURING SECURITY POSTURE USING COMBINED-GRAPHS

(71) Applicant: Telefonaktiebolaget LM Ericsson (publ), Stockholm (SE)

(72) Inventors: Md Nazmul HOQ, Montreal (CA); Suryadipta MAJUMDAR, Montreal (CA); Lingyu WANG, Montreal (CA); Jiawei YAO, Montreal (CA); Mourad DEBBABI, Dollard Des Ormeaux (CA); Makan POURZANDI, Montreal (CA); Amine BOUKHTOUTA, Laval (CA); Luis SUÁREZ, Montreal (CA)

(21) Appl. No.: 19/147,809

(22) PCT Filed: Jan. 19, 2024
(86) PCT No.: PCT/IB2024/050537

§ 371 Date: Jul. 14, 2025

Related U.S. Application Data
(60) Provisional application No. 63/480,763, filed on Jan. 20, 2023.

(51) Int. Cl. H04L 9/40

(52) U.S. Cl. CPC H04L 63/1433; H04L 63/1425

(57) ABSTRACT

A method in a network element configured to determine a security posture value associated with a system is described. The method includes determining a normal event graph based at least on log data included in logs associated with a network, determining a noncompliant graph based at least on breach event information, and generating a combined graph by combining the normal event graph with the noncompliant graph. The method further includes determining the security posture value associated with the system using the combined graph and optionally, performing one or more actions based on the security posture value.

### TECHNICAL FIELD

The present disclosure relates to wireless communications, and in particular, to measuring the security posture of a communication system.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network elements, such as base stations, and mobile wireless devices (WD), as well as communication between network elements and between WDs. The 3GPP is also developing standards for Sixth Generation (6G) wireless communication networks.

Communication systems (such as 5G wireless systems) may comprise a wide range of network function (NF) deployments. NF deployments may encounter problems associated with system security and/or reliability. For example, NFs may encounter configuration errors, be vulnerable to insider threats, or be the target of cyberattacks. Some security principles may be used to address some of the problems encountered by NFs. However, there is no specification that provides guidance on the continuous evaluation of trust level of any NF(s) involved in 5G network such as 5G core networks.

Although the security posture of a 5G network system may be measured, measuring overall security posture in 5G network system has many challenges due to the exigences and constraints that these types of networks pose. For example, if an NF is compromised or under attack, the services offered by the NF may also be impacted. Lateral movement of the threat to other connected NF can further increase the threat surface and may lead to network compromise and attacks, posed by organizations such as Advanced Persistent Threat (APT) adversaries. An APT is defined by National Institute of Standards and Technology (NIST)as an adversary that possesses sophisticated levels of expertise and significant resources which allow it to create opportunities to achieve its objectives by using multiple attack vectors including, for example, cyber, physical, and deception. Further, collecting data from all the NF and related services and aggregating them maintaining the actual and precise timestamp may be difficult.

In addition, various events within the NF lifecycle (apart from static configuration at deployment) may impact the measurement of the security posture, e.g., require dynamic data collection and repetitive calculation of the security posture. Further, conventional security metrics are based on attack graphs which consist only of attack events. These security metrics cannot be used for simulating other attacks such as insider attacks by APT. In addition, an overall reflection of the security posture may not be had using single aspects (i.e., user, network, infrastructure, etc.), and auditing methods mainly provide binary results (e.g., compliant, or not) or are specific to certain security policy.

Other conventional technologies for managing system security are either based on existing vulnerability databases or focused on particular aspects of the system such as scores. However, existing vulnerability databases may not be up to date, and scores such as common vulnerability scoring system (CVSS) scores of individual vulnerabilities may fail to reflect the dependency relationship between multiple compliance breaches.

In sum, conventional technology is inadequate to measure the security posture of systems, in particular, wireless communication systems such as 5GS.

### SUMMARY

Some embodiments advantageously provide methods, systems, and apparatuses for measuring security posture using combined-graphs.

In one or more embodiments, security principles such as Zero Trust Security Principles may be adapted to 5G core network(s) where the basis is continuous trust status validation as a core aspect of the key tenets (i.e., monitoring the state, setting access control policies, and implementing real-time verification). Further, Zero Trust Security Principles may be used for minimizing impacts if any security breach occurs due to external factors or by an insider.

The Zero Trust paradigm describes seven tenets, where two of them are related to security posture measure and calculation: (i) tenet 5 validates the need to have widespread and continuous monitoring of the assets and measurement of their security posture; and (ii) tenet 7 states the need to have data collection mechanisms that conveys information about the state of assets, the network infrastructure, and the communication between the assets (which may be used to determine a security posture). In some embodiments, to improve overall security posture of a system/network (e.g., compared to conventional systems), historical statistics, security posture and risk aspects may be used, and mitigation steps and decisions may be applied.

In some embodiments, an overall security posture includes multiple aspects of the system (i.e., user aspect, network aspect, infrastructure aspect, etc.) and combining one or more the aspects (e.g., under one hood). Determining the overall security posture may comprise finding out the attributes or factors that could combine multiple aspects, aggregating the measurement of each aspect, etc. The determination may further comprise finding out the relevant security compliances from different security standards for the overall 5G system and attributing the correct data sources to them. In addition, the compliance results of respective security policy from different security appliances (i.e., binary auditing results) may be converted into a numeric value.

According to one aspect, a system is described. The system may comprise a security posture calculator (SePoCal). The system may be configured to determine an overall security posture of the system using security controls from various security standards, auditing findings, and normal events logs. In some other embodiments, the system transforms the auditing systems' binary results (compliance or breach) into a non-binary numerical security posture score. In some embodiments, information from several perspectives (user, network, infrastructure, etc.) may be used to generate a single security posture value for the entire system.

In one or more embodiments, the system normal event data is analyzed to construct a normal event graph (e.g., to understand the event dependencies). The system logs data may be collected and then filtered to remove irrelevant and unwanted events. Event sequences from the filtered logs may be created based on their timestamps. In some embodiments, a network such as a Bayesian network be determined using the event sequences, which may be considered as normal event graph. Further, one or more auditing methods and their results of compliance or non-compliance with security standards may be used such as to construct a non-compliant event graph (e.g., using the MITRE adversarial tactics, techniques, and common knowledge (ATT&CK) framework and/or expert assistance).

In some other embodiments, one or more of the steps described in the present disclosure may be performed for different components of the system. In some embodiments, the normal event graph may be merged with the non-compliance event graph to generate a complete model. To merge these two different graphs, the common nodes among the graphs may be identified. All the parents of each common node may also be listed. For each common node, the parent nodes from each graph may be merged (i.e., horizontal combination). Further, the graph may be vertically combined using a common node, (for example, privilege escalation) among all the events may be found. The nodes may be added to the graph to connect multiple nodes from different aspects (i.e., vertical combination).

In some embodiments, a network such as a Bayesian Network (BN) may be used to calculate a conditional probability for each node. In some other embodiments, the system security state of the goal node may be determined using an evaluator which uses a Bayesian inference to calculate the overall posture value.

In some embodiments, security metrics may be based on an attack graph which comprise the attack events and may be used to simulate probabilities of a breach happening. In some other embodiments, other events such as normal events of the system may be used. Using other events may be crucial in the overall security and may be used in simulating insider attacks or Advanced Persistent Attack (APT) in a system.

Further, a Security Manager (SM), which centralizes security concerns system-wide, for one security trust domain may be used. The SM supervises the security of the NF virtualization (NFV) components and acts as a centralized repository of security related information which is supported by the monitoring capabilities of security agents (SA) and other Network Management Systems (NMS). Due to these functionalities, the system (e.g., SePoCal) can fit into the role of the SM, enhancing its capabilities. The enhanced SM can be used to calculate the security posture of the assets composing that domain. According to that security posture, actions can be triggered to the involved assets via the NFV orchestrator (NFVO), virtualized network function manager (VNFM) and virtual infrastructure manager (VIM), e.g., to improve the security posture of VNFs and underlying infrastructure. Moreover, the SA can incorporate these capabilities, in case a fine-grained security posture is needed, according to one or more embodiments.

Further, NFs that relate to Network Slice (Subnet) Management Function (NS(S)MF) and Network Function Management Function (NFMF) are described. The NFs may perform configuration management, fault management and performance management. These functions can trigger configuration and corrective actions according to information collected from monitoring functions. The NFs can be modified with the features of the system (e.g., SePoCal).

In some embodiments, an NF such as a network data analytics function (NWDAF) is described. The NWDAF may be configured to collect events from NFs, retrieve information from repositories (user data, analytics), and retrieve information (service and management) about NFs. As a NF that has collection, analytics, and provisioning capabilities for the 5G network, the NWDAF may be configured with the capabilities provided by SePoCal. After the data collection, analytics and security posture calculation process, corrective actions can be sent to the NFV management and orchestration (MANO) entities.

Correct measurement of security posture is beneficial at least because the overall security state of the system may be assessed, and steps may be performed and decisions made to improve the overall security posture (e.g., if a value drops below a certain threshold). Further, having a measurement of the overall security status in a dynamic 5G system helps to enhance security, resilience, and high availability.

In some embodiments, system logs data are collected and then the data is filtered to remove irrelevant and unwanted events. Different kinds of logs data (i.e., system level logs, application-level logs (free5gc), infrastructure level logs (Kubernetes), etc.) may be collected. After processing the logs, logs are ordered and merged based on timestamp. Event sequences may be created from the merged logs based on the cycle presented in event lists. A Bayesian network (BN) is built using the event sequences which may be considered as normal event graph. Normal event graph may represent the dependency of the normal events of the whole system with the transition probability from one state to another. That is, the combination of different levels of logs and generation of the dependency of the normal events with their transition probability using BN may be used to address one or more drawbacks of conventional technology.

In some other embodiments, security compliance processes (i.e., auditing, system monitoring tools, etc.) and their results of compliance or non-compliance may be used in addition to security controls from security standards. Security standards may comprise standards promulgated by NIST, European Union Agency for Cybersecurity (ENISA), Center for Internet Security (CIS), CCM, etc.). Security compliance processes may be used to build a non-compliance graph and/or breach event graph. Security compliance processes may determine a binary result, e.g., whether it is compliant or non-compliant with a particular security control. A count of the non-compliance and the probability of non-compliance for each security control may be determined. A pre-condition of or the reason for the non-compliance and the post condition or the immediate effects of the non-compliance in the system may be also determined. A graph connecting them together may be generated. This may be repeated for each non-compliance control, and if there are more than one pre-condition, or post condition, the pre-condition and/or post condition may be added to the respective graph of non-compliance control. Further, based on the pre-condition and post-condition of the non-compliance control, the individual graph and built a non-compliance graph may be merged with the probability of non-compliance from the historical data from security compliance. This way of generating a non-compliance graph using the existing security compliances results with a probability value may be used to address one or more drawbacks of conventional technology.

In some embodiments, the normal event graph is merged with the non-compliance event graph to generate another graph (e.g., a complete graph). To merge these two different graphs, the common nodes among the graphs and then list all the parents of each common node are identified. For each common node, the parent nodes from each graph may be merged (i.e., horizontal combination). The graph may be vertically combined, where the privilege escalation nodes among all the events are found and added to the graph to connect multiple nodes from different aspects (i.e., vertical combination). This way of combining horizontally and vertically to generate a complete graph of the system that can depict the overall status of the system may be used to address one or more drawbacks of conventional technology.

In some other embodiments, a Bayesian Network (BN) may be used to calculate the conditional probability for each node, where the conditional probability may reflect the probability of occurring events. The input to the Bayesian network may be the complete graph (e.g., from a previous step). Further, the user can also define which is the critical event that is mostly concerned, i.e., the goal node. The system security state of the goal node may be determined using the evaluator which uses the Bayesian inference to calculate the overall posture value.

One or more embodiments have multiple usage and advantages over conventional technology. For example, an overall status about the system may be determined, the characteristics of the system determined and/or shown, and attacker behavior in the system may be modeled. Other examples of advantages are as follows:
The system fulfills the requirement(s) of a tool to give an overall posture value of the system and combines different aspects by collecting logs from different levels (i.e., system level, user level, infrastructure level, and from application level). Historical data from existing security compliances (i.e., auditing system, monitoring system, etc.) may be used. The combination of this information provides at least an overall idea/status of the system.
The system may be configured to not be specific to any vulnerability database or following any specific threat models. Standard security controls and the existing auditing system results may be used to capture information about non-compliance of the security controls. Historical logs data may be used to capture the normal behavior of the system and then combined with the non-compliance information which gives a snapshot of the system (e.g., for addressing insider attacks, exploitation of data, etc.).
The system may determine a future security posture for each event of the system using probabilistic Bayesian Network which is modular and can be parameterized based on the user defined goal node. This may be helpful to security administrators such as for checking different security points (critical events) individually and give importance to specific security points.
The system can also be used to improve the performance of existing security compliances, security manager, 3GPP security trust evaluator, etc.
The system can also be used to model an attacker behavior as it captures and connects individual events and calculates their dependency relation using BN. Specifically, attacker behavior can be modeled by determining the capability level of an attacker using the measured attacker success ratio (ASR) and security posture value. As the attacker's capability grows, the attacker success ratio increases while the security posture value decreases.

According to one aspect, a method in a network element configured to determine a security posture value associated with a system is described. The method includes determining a normal event graph based at least on log data comprised in logs associated with a network, determining a noncompliant graph based at least on breach event information, and generating a combined graph by combining the normal event graph with the noncompliant graph. The method further includes determining the security posture value associated with the system using the combined graph and optionally, performing one or more actions based on the security posture value.

In some embodiments, the generating of the combined graph includes performing a horizontal combination of the normal event graph and the noncompliant graph.

In some other embodiments, the performing the horizontal combination includes one or more of determining one or more common nodes between the normal event graph and the noncompliant graph; determining one or more parent nodes for each of the normal event graph and the noncompliant graph; and for each common node of the one or more common nodes, merge the corresponding parent nodes from for each of the normal event graph and the noncompliant graph.

In some embodiments, the generating of the combined graph further includes performing a vertical combination of the normal event graph and the noncompliant graph.

In some other embodiments, the performing of the vertical combination includes determining privilege escalation information based at least on the breach event information and adding the privilege escalation information to a node of the combined graph to generate a privilege escalation node.

In some embodiments, the performing of the vertical combination further includes determining an impact node associated with privilege escalation based on the privilege escalation information and connecting the impact node with the privilege escalation node to show a security attack progress.

In some other embodiments, the determining of the security posture value includes building a Bayesian Network (BN) based on the combined graph.

In some embodiments, the determining of the security posture further includes identifying a goal node of the BN usable to determine the security posture, the goal node corresponding to a critical security event.

In some other embodiments, the method further includes determining a conditional probability associated with the goal node based at least on one probability associated with other nodes of the combined graph, the conditional probability indicating a probability that an attacker may reach the goal node.

In some embodiments, the combined graph includes at least a normal event, a non-compliant event, a pre-condition associated with a breach event, and a post-condition associated with the breach event.

According to another aspect, a network element configured to determine a security posture value associated with a system is described. The network element is configured to determine a normal event graph based at least on log data comprised in logs associated with a network, determine a noncompliant graph based at least on breach event information, and generate a combined graph by combining the normal event graph with the noncompliant graph. The network element is also configured to determine the security posture value associated with the system using the combined graph and optionally, perform one or more actions based on the security posture value.

In some embodiments, the generating of the combined graph includes performing a horizontal combination of the normal event graph and the noncompliant graph.

In some other embodiments, the performing the horizontal combination includes one or more of determining one or more common nodes between the normal event graph and the noncompliant graph; determining one or more parent nodes for each of the normal event graph and the noncompliant graph; and for each common node of the one or more common nodes, merge the corresponding parent nodes from for each of the normal event graph and the noncompliant graph.

In some embodiments, the generating of the combined graph further includes performing a vertical combination of the normal event graph and the noncompliant graph.

In some other embodiments, the performing of the vertical combination includes determining privilege escalation information based at least on the breach event information and adding the privilege escalation information to a node of the combined graph to generate a privilege escalation node.

In some embodiments, the performing of the vertical combination further includes determining an impact node associated with privilege escalation based on the privilege escalation information and connecting the impact node with the privilege escalation node to show a security attack progress.

In some other embodiments, the determining of the security posture value includes building a Bayesian Network (BN) based on the combined graph.

In some embodiments, the determining of the security posture further includes identifying a goal node of the BN usable to determine the security posture, the goal node corresponding to a critical security event.

In some other embodiments, the network node is further configured to determine a conditional probability associated with the goal node based at least on one probability associated with other nodes of the combined graph, the conditional probability indicating a probability that an attacker may reach the goal node.

In some embodiments, the combined graph includes at least a normal event, a non-compliant event, a pre-condition associated with a breach event, and a post-condition associated with the breach event.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network element with a wireless device over an at least partially wireless connection according to some embodiments of the present disclosure;

FIG. 3 is a flowchart illustrating example methods implemented in a communication system including a host computer, a network element and a wireless device for executing a client application at a wireless device according to some embodiments of the present disclosure;

FIG. 4 is a flowchart illustrating example methods implemented in a communication system including a host computer, a network element and a wireless device for receiving user data at a wireless device according to some embodiments of the present disclosure;

FIG. 5 is a flowchart illustrating example methods implemented in a communication system including a host computer, a network element and a wireless device for receiving user data from the wireless device at a host computer according to some embodiments of the present disclosure;

FIG. 6 is a flowchart illustrating example methods implemented in a communication system including a host computer, a network element and a wireless device for receiving user data at a host computer according to some embodiments of the present disclosure;

FIG. 7 is a flowchart of an example process in a network element according to some embodiments of the present disclosure;

FIG. 8 is a flowchart of another example process in a network element according to some embodiments of the present disclosure;

FIG. 9 shows illustrates an example system overview according to some embodiments of the present disclosure;

FIG. 10 shows an example system architecture according to some embodiments of the present disclosure;

FIG. 11 shows an example horizontal graph combination of a normal event graph and a non-compliant graph according to some embodiments of the present disclosure;

FIG. 12 shows an example vertical combination according to some embodiments of the present disclosure;

FIG. 13 shows an example combined graph where normal event graph and non-compliant graph are merged according to some embodiments of the present disclosure;

FIG. 14 is a sequence diagram showing an example process according to some embodiments of the present disclosure;

FIG. 15 shows example interactions of an administrator (admin) and an expert with a network element according to some embodiments of the present disclosure;

FIG. 16 shows an example impact of attacker capability on the system according to some embodiments of the present disclosure; and

FIG. 17 shows an example impact of different attack stages according to some embodiments of the present disclosure.

### DETAILED DESCRIPTION

Before describing in detail example embodiments, it is noted that the embodiments reside primarily in combinations of apparatus components and processing steps related to measuring security posture using combined-graphs. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network element” used herein can be any kind of network element (NE) comprised in network. The network element may be any computing device or server. Further, the network may be a radio network. The NE may comprise any of base station (BS), radio base station, base transceiver station (BTS), base station controller (BSC), radio network controller (RNC), gNodeB (gNB), evolved NodeB (eNB or eNodeB), NodeB, multi-standard radio (MSR) radio element such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network element (e.g., mobile management entity (MME), self-organizing network (SON) node, a coordinating node, positioning node, MDT node, etc.), an external node (e.g., 3^{rd} party node, a node external to the current network), nodes in distributed antenna system (DAS), a spectrum access system (SAS) node, an element management system (EMS), etc. The network element may also comprise test equipment. In some embodiments, the NE may comprise any of a Network Slice Selection Function(NSSF), Network Repository Function (NRF), Unified Data Management (UPF), Session Management Function (SMF), Policy Control Function(PCF), etc. In some other embodiments, the NE may comprise an NFV Orchestrator (NFVO) a VNF Manager (VNFM), a Virtualized Infrastructure Manager (VIM), a security appliance, etc. In some embodiments, the NE may comprise any of an NS(S)MF, Network Data Analytics Function (NWDAF), Network Function Management Function (NFMF), Security Agents (SA), Network Management Systems (NMS), MANO, etc. The term “radio element” used herein may be used to also denote a wireless device (WD) such as a wireless device (WD) or a radio network element.

In some embodiments, the non-limiting terms wireless device (WD) or a user equipment (UE) are used interchangeably. The WD herein can be any type of wireless device capable of communicating with a network element or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device etc.

Also, in some embodiments the generic term “radio network element” is used. It can be any kind of a radio network element which may comprise any of base station, radio base station, base transceiver station, base station controller, network controller, RNC, NB, NodeB, gNB, Multi-cell/multicast Coordination Entity (MCE), relay node, access point, radio access point, Remote Radio Unit (RRU) Remote Radio Head (RRH).

In some embodiments, the term event is used and may refer to an event associated with a network element, a wireless device, and/or any component of a communication system. In some other embodiments, an event may comprise a normal event and other events. A normal event may be any event which may be classified as normal based on one or more criteria. In some embodiments, a normal event may refer to an event that is not immediately associated with a security risk.

In some embodiments, the term “security posture” may refer to a security status such as of a network, information, and systems. The security posture may be based on information security resources (e.g., people, hardware, software, policies) and capabilities usable to manage security the network, information, and system. In some embodiments, security posture is a value that demonstrates how secure a system or system component is. In some other embodiments, e.g., in 3GPP systems, the security posture of a network (e.g., 5G network) may be defined from two main factors: (i) by checking how well security practices and guidelines are followed in a deployment (e.g., 5G deployment) and its operation (as captured in our state model); and (ii) by monitoring network elements, infrastructure, and communication (as captured in our event model).

In some embodiments the term “node” is used and may refer to a data structure components such as a data structure node, a graph node, a linked node, etc. One or more nodes may be associated with data or information, e.g., security data, security information, etc. Put differently, a data structure such as a graph may comprise one or more nodes, each node may be arranged according to one or more criteria and may have one or more dependencies. Each node may be a parent node, a child node, or any other type of node. In some other embodiments, the term “Node” such as gNodeB, NodeB, eNodeB is used. However, gNodeB, NodeB, eNodeB are used in the context of network elements (i.e., are not nodes in the context of data structures).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network element may be distributed over a plurality of wireless devices and/or network elements. In other words, it is contemplated that the functions of the network element and wireless device described herein are not limited to performance by a single physical device and, in fact, can be distributed among several physical devices.

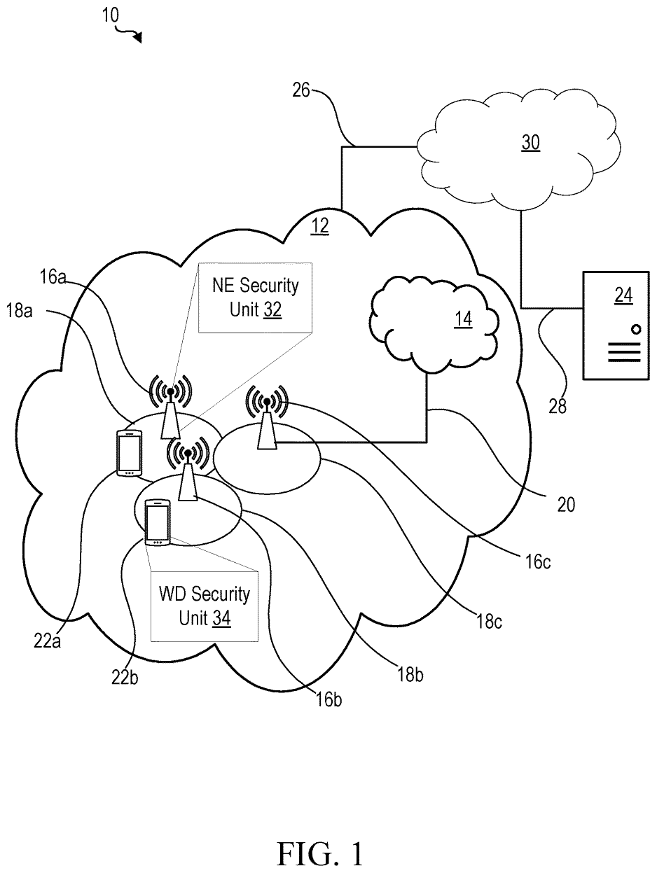

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network elements 16a, 16b, 16c (referred to collectively as network elements 16), such as NBs, eNBs, gNBs or other types of wireless access points, each defining a corresponding coverage area 18a, 18b, 18c (referred to collectively as coverage areas 18). Each network element 16a, 16b, 16c is connectable to the core network 14 over a wired or wireless connection 20. A first wireless device (WD) 22a located in coverage area 18a is configured to wirelessly connect to, or be paged by, the corresponding network element 16a. A second WD 22b in coverage area 18b is wirelessly connectable to the corresponding network element 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network element 16. Note that although only two WDs 22 and three network elements 16 are shown for convenience, the communication system may include many more WDs 22 and network elements 16.

Also, it is contemplated that a WD 22 can be in simultaneous communication and/or configured to separately communicate with more than one network element 16 and more than one type of network element 16. For example, a WD 22 can have dual connectivity with a network element 16 that supports LTE and the same or a different network element 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network element 16 may not or need not be informed about the past routing of an incoming downlink communication with data originating from a host computer 24 to be forwarded (e.g., handed over) to a connected WD 22a. Similarly, the network element 16 need not be aware of the future routing of an outgoing uplink communication originating from the WD 22a towards the host computer 24.

A network element 16 is configured to include a NE security unit 32 which is configured to perform any step and/or task and/or process and/or method and/or feature described in the present disclosure, e.g., determine a security posture. A wireless device 22 is configured to include a WD security unit 34 which is configured to perform any step and/or task and/or process and/or method and/or feature described in the present disclosure such as those described with respect to NE security unit 32.

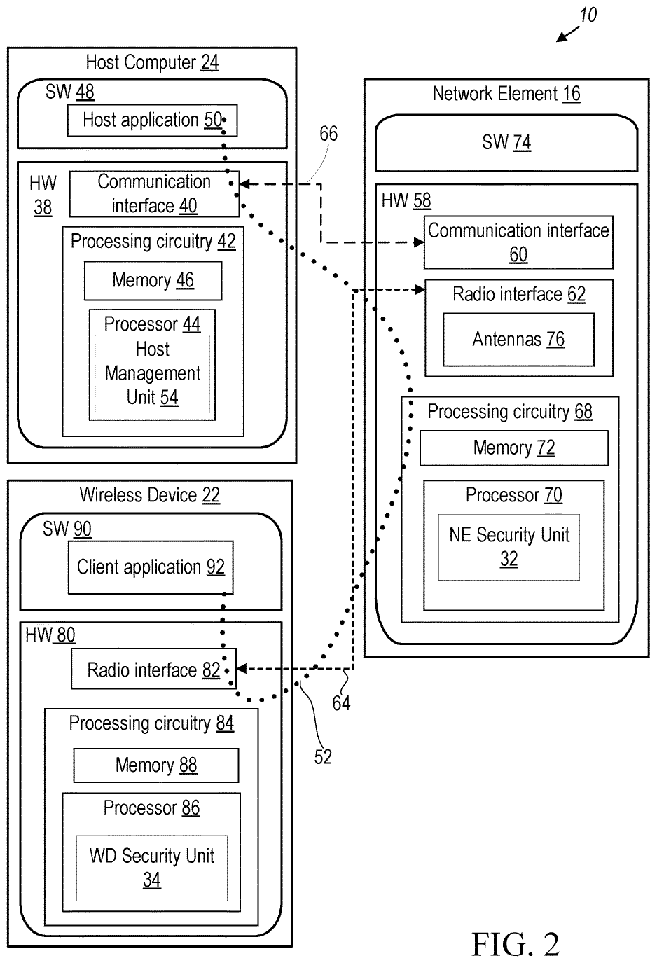

Example implementations, in accordance with an embodiment, of the WD 22, network element 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network element 16 and or the wireless device 22.

The communication system 10 further includes a network element 16 provided in a communication system 10 and includes hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network element 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network element 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network element 16 further has software 74 stored internally in, for example, memory 72, or stored in external memory (e.g., database, storage array, network storage device, etc.) accessible by the network element 16 via an external connection. The software 74 may be executable by the processing circuitry 68. The processing circuitry 68 may be configured to control any of the methods and/or processes described herein and/or to cause such methods, and/or processes to be performed, e.g., by network element 16. Processor 70 corresponds to one or more processors 70 for performing network element 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network element 16. For example, processing circuitry 68 of the network element 16 may include a NE security unit 32 which is configured to perform any step and/or task and/or process and/or method and/or feature described in the present disclosure, e.g., determine a security posture.

The communication system 10 further includes the WD 22 already referred to. The WD 22 may have hardware 80 that may include a radio interface 82 configured to set up and maintain a wireless connection 64 with a network element 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include WD security unit 34 which is configured to perform any step and/or task and/or process and/or method and/or feature described in the present disclosure such as those described with respect to NE security unit 32.

In some embodiments, the inner workings of the network element 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network element 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network element 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network element 16, and it may be unknown or imperceptible to the network element 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network element 16 with a radio interface 62. In some embodiments, the network element 16 is configured to, and/or the network element's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network element 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network element 16, and/or preparing/terminating/maintaining/supporting/ending in receipt of a transmission from the network element 16.

Although FIGS. 1 and 2 show various “units” such as NE security unit 32, and WD security unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

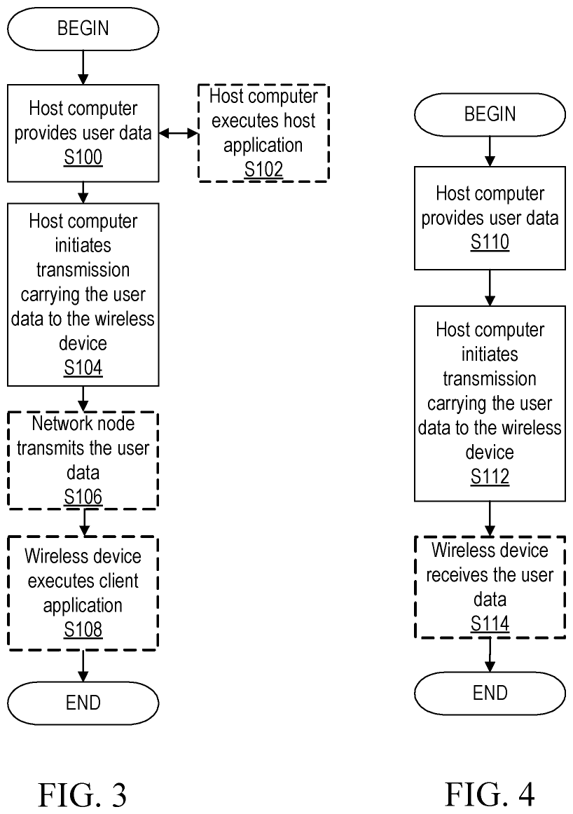

FIG. 3 is a flowchart illustrating an example method implemented in a communication system, such as, for example, the communication system of FIGS. 1 and 2, in accordance with one embodiment. The communication system may include a host computer 24, a network element 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network element 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network element 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network element 16, in accordance with the teachings of the embodiments described throughout this disclosure. In an optional third step, the WD 22 receives the user data carried in the transmission (Block S114).

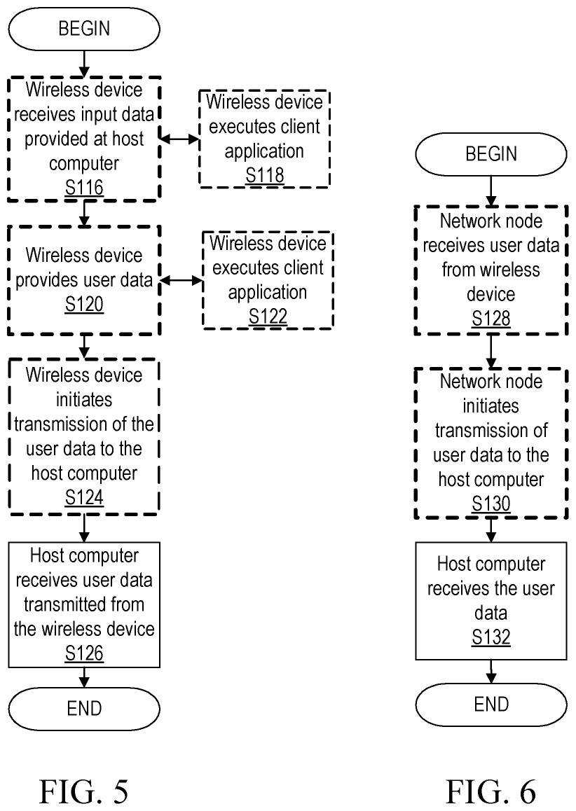

FIG. 5 is a flowchart illustrating an example method implemented in a communication system, such as, for example, the communication system of FIG. 1, in accordance with one embodiment. The communication system may include a host computer 24, a network element 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network element 16 and a WD 22, which may be those described with reference to FIGS. 1 and 2. In an optional first step of the method, in accordance with the teachings of the embodiments described throughout this disclosure, the network element 16 receives user data from the WD 22 (Block S128). In an optional second step, the network element 16 initiates transmission of the received user data to the host computer 24 (Block S130). In a third step, the host computer 24 receives the user data carried in the transmission initiated by the network element 16 (Block S132).

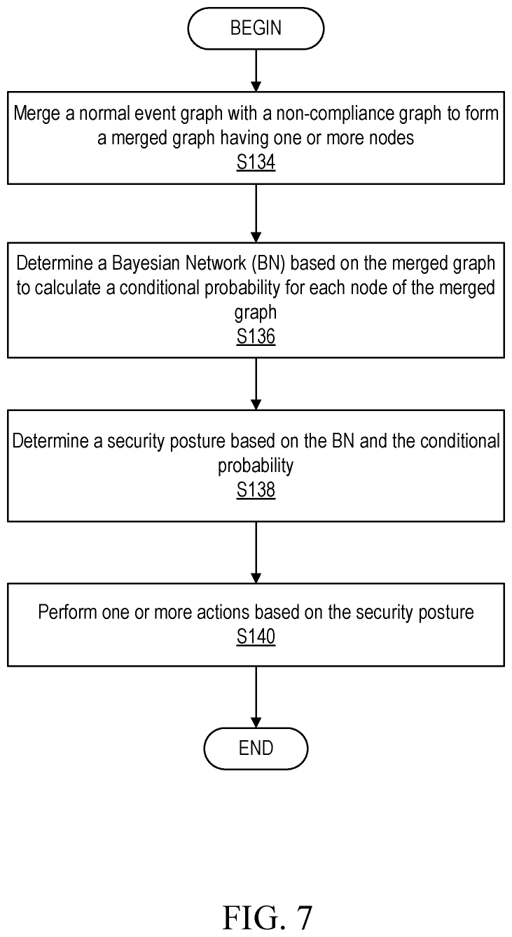

FIG. 7 is a flowchart of an example process (i.e., method) in a network element 16. One or more blocks described herein may be performed by one or more elements of network element 16 such as by one or more of processing circuitry 68 (including the NE security unit 32), processor 70, radio interface 62 and/or communication interface 60. Network element 16 such as via processing circuitry 68 and/or processor 70 and/or radio interface 62 and/or communication interface 60 is configured to merge (Block S134) a normal event graph with a non-compliance graph to form a merged graph having one or more nodes; determine (Block S136) a Bayesian Network (BN) based on the merged graph to calculate a conditional probability for each node of the merged graph; determine (Block S138) a security posture based on the BN and the conditional probability; and perform (Block S140) one or more actions based on the security posture.

In some embodiments, the method comprises determining the normal event graph based on normal event data.

In some other embodiments, the method comprises determining the non-compliance graph based on security compliance information.

In some embodiments, the method comprises determining a goal node and a security state of the goal node using a BN inference to determine the security posture.

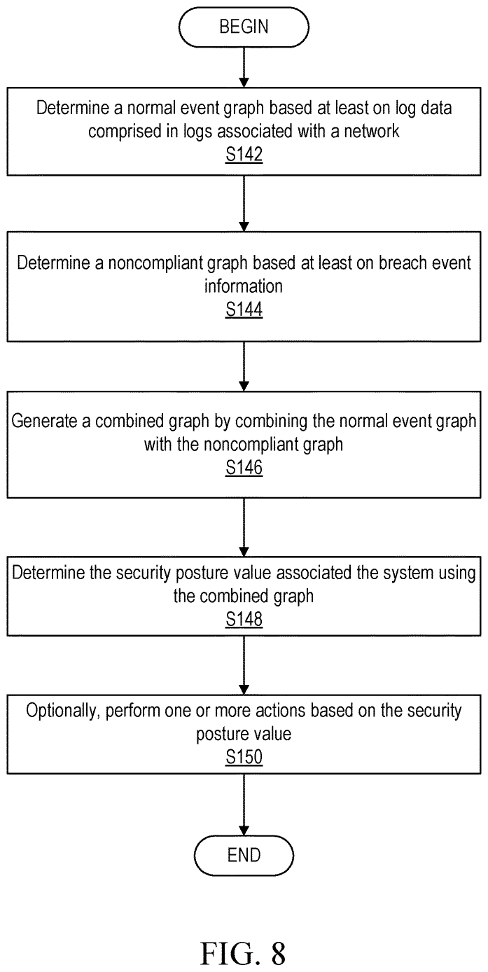

FIG. 8 is a flowchart of another example process (i.e., method) in a network element 16. One or more blocks described herein may be performed by one or more elements of network element 16 such as by one or more of processing circuitry 68 (including the NE security unit 32), processor 70, radio interface 62 and/or communication interface 60. Network element 16 such as via processing circuitry 68 and/or processor 70 and/or radio interface 62 and/or communication interface 60 is configured to determine (Block S142) a normal event graph 114 based at least on log data comprised in logs associated with a network 102, determine (Block S144) a noncompliant graph 116 based at least on breach event information, and generate a combined graph by combining the normal event graph 114 with the noncompliant graph 116. The method further includes determining the security posture value associated with the system 10 using the combined graph and optionally, performing one or more actions based on the security posture value.

In some embodiments, the generating of the combined graph includes performing a horizontal combination of the normal event graph and the noncompliant graph.

In some other embodiments, the performing the horizontal combination includes one or more of determining one or more common nodes between the normal event graph and the noncompliant graph; determining one or more parent nodes for each of the normal event graph and the noncompliant graph; and for each common node of the one or more common nodes, merge the corresponding parent nodes from for each of the normal event graph and the noncompliant graph.

In some embodiments, the generating of the combined graph further includes performing a vertical combination of the normal event graph and the noncompliant graph.

In some other embodiments, the performing of the vertical combination includes determining privilege escalation information based at least on the breach event information and adding the privilege escalation information to a node of the combined graph to generate a privilege escalation node.

In some embodiments, the performing of the vertical combination further includes determining an impact node associated with privilege escalation based on the privilege escalation information and connecting the impact node with the privilege escalation node to show a security attack progress.

In some other embodiments, the determining of the security posture value includes building a Bayesian Network (BN) based on the combined graph.

In some embodiments, the determining of the security posture further includes identifying a goal node of the BN usable to determine the security posture, the goal node corresponding to a critical security event.

In some other embodiments, the method further includes determining a conditional probability associated with the goal node based at least on one probability associated with other nodes of the combined graph, the conditional probability indicating a probability that an attacker may reach the goal node.

In some embodiments, the combined graph includes at least a normal event, a non-compliant event, a pre-condition associated with a breach event, and a post-condition associated with the breach event.

Having described the general process flow of arrangements of the disclosure and having provided examples of hardware and software arrangements for implementing the processes and functions of the disclosure, the sections below provide details and examples of arrangements for measuring security posture using combined-graphs.

In one or more embodiments, a device, method and system (e.g., SePoCal) that determines an overall security posture value of a system 10 is described. The determination may be based on historical log data (e.g., 5G system historical log data) as well as the historical data generated by different existing security compliances.

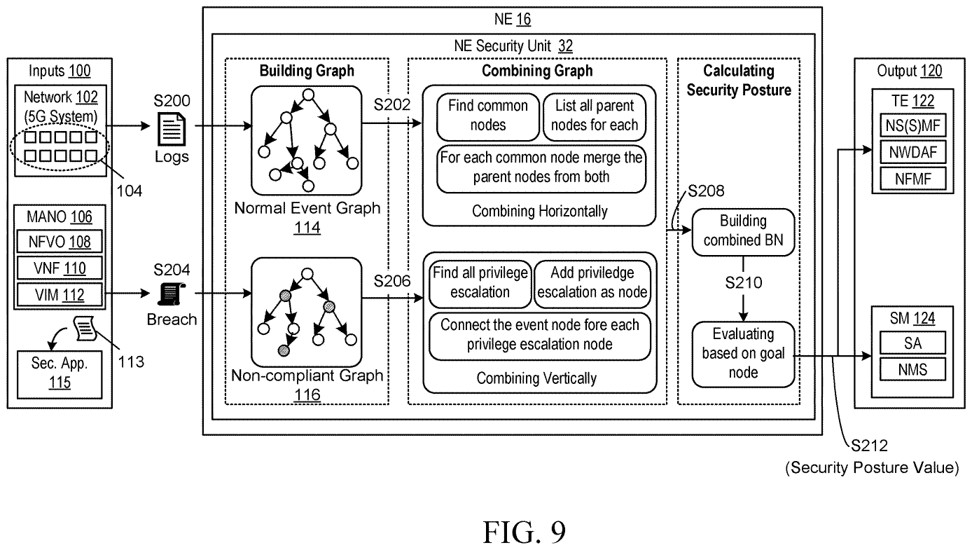

FIG. 9 illustrates an example system overview (e.g., comprising network element 16 configured to perform one or more steps associated with SePoCal). More specifically, NE 16 may comprise NE Security Unit 32. NE 16 and NE Security Unit 32 may receive inputs 100, which may include data and/or information from network 102 (e.g., 5G System) and/or MANO 106. Network 102 may comprise network elements or devices 104 such as NSSF, NRF, UDM, UPF, UE, SMF, PCF, gNB, etc. any of which may be configured with a container orchestration system such as Kubernetes and other networking components. MANO 106 may comprise any of an NFVO 108, VNFM 110, VIM 112, etc. which may provide breach events information to NE 16. Inputs 100 may include and/or be based on security policy 113 associated with security appliances 115. In some embodiments, inputs 100 may include logs and/or at least one breach (or breach event information). More specifically, at step S200 logs may be received by NE 16 (e.g., to build a normal event graph 114). At step S202, the graph may be used as part of a graph combination process. At step S204, a breach (or breach event information) may be received at NE 16 and used to build a non-compliant graph 116. At step S206, the graph may be used by the graph combination process. At step S208 a combined graph is provided to calculate a security posture (e.g., by building a combined BN. At step S210, the combined BN may be evaluated based on goal node(s). At step S212, a security posture (or security posture value) is provided as an output 120, which may be used by a trust evaluator 122 (e.g., 3GPP Trust Evaluator) and/or SM 124 or any other network element or component of system 10. For example, trust evaluator may include an NS(S)MF, NWDAF, NFMF, etc., and SM may include an SA and/or an NMS.

The graph combination process may include performing horizontal combination of graphs (e.g., step S202) and/or vertical combination of graphs (e.g., step S206). Performing horizontal combination of graphs may include finding common nodes, listing parent nodes for each graph, and for each common node, merging the parent nodes from graphs. Performing vertical combination of graphs may include finding privilege escalation, adding privilege escalation as a node, connecting an event node for each privilege escalation node.

In some embodiments, log data (e.g., and/or logs) such as normal log data from a 5G system may be collected (e.g., using security agents). Logs from system level and/or infrastructure level may be collected. Further, data from security compliance (e.g., network elements configured to provide security compliance information) may be collected based on the security policy or security controls (e.g., defined in a standard security framework such as NIST, CCM, CIS, etc.). MANO 106 may be used to collect such data. From these two kinds of data, two different graphs using the Bayesian Network (i.e., Normal Bayesian Network and Non-compliant Bayesian Network). By combining normal event BN and non-compliant BN, a graph is determined/created. The graph feeds again to a BN to build a model. The model may be used to determine information about the security posture value of the system which can further be used in different applications such as SM 124, and 3GPP trust evaluator 122 (i.e., NWDAF, NFMF, etc.).

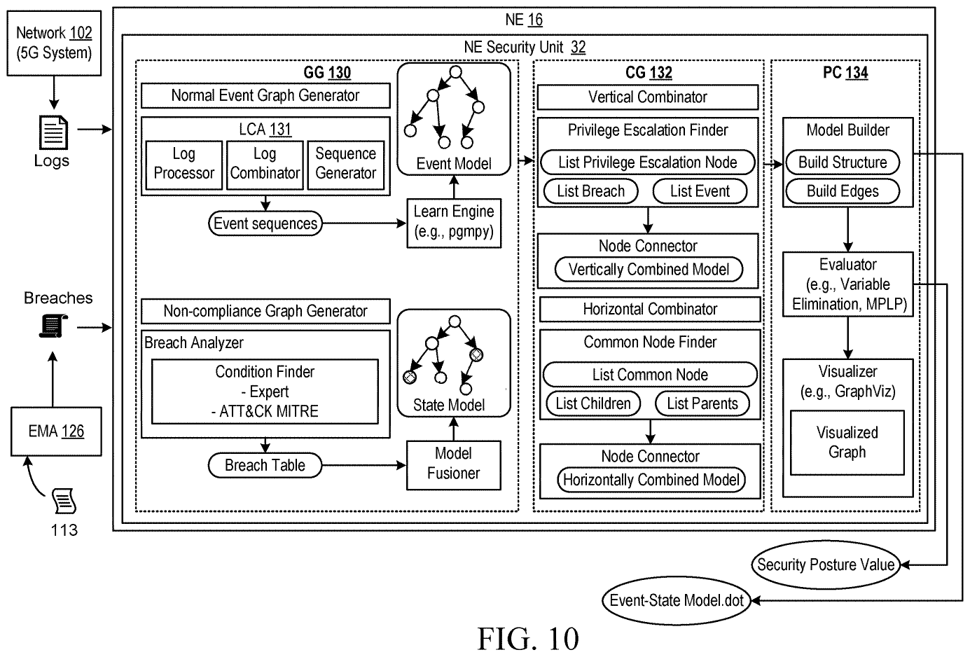

FIG. 10 shows an example system architecture (e.g., of a SePoCal system) comprising one or more modules (which may be comprised in and/or performed by, for example, NE 16 and/or NE security unit 32 or some other network element (not shown)), which may receive logs and/or breach information from network 102 and EMA 126 (based on security policy 113), respectively:
Event Monitor and Auditor (EMA) 126: This module may be configured for monitoring any non-compliance of security controls. It reports the policy or security control breaches. The reports may be used by users such as experts that interpret it and work on identifying the pre and post condition of the breach.
Log Collector and Analyzer (LCA) 131: This module may include a log processor, log combinator, and sequence generator and may be configured for the configuration of the data source from where the data is fetched (i.e., from a monitoring tool, or the system file). This collects different levels of logs and store them in a secure location (e.g., memory 72). LCA 131 may produce event sequences which may be used by a learning engine to generate an event model.
Graph Generator (GG) 130: GG 130 may include LCA 131, a normal events graph generator, a non-compliance graph generator, a breach analyzer and a condition finder (including expert input and MITRE ATT&CK features). The breach analyzer may generate a breach table (e.g., usable by a model fusion to produce state model). GG 130 may be configured for generating the normal events graph from the historical log data and the non-compliant event graph from the policy breach or the auditing results. Specifically:
   (i) the normal events graph can cover attacker's activities that involve procedures supported by 5G network. As a source of events, the monitoring results (e.g., event logs) may be collected from multiple sources of a network (e.g., 5G network) to cover its different aspects. Subsequently, the logs from different sources may be combined based on their timestamp, resulting in a single processed log. To capture attacker activities (represented as a BN), event sequences may be generated where each sequence ends as soon as any event is repeated to avoid cycles in our model (mainly because a BN is acyclic). An event model may also be constructed.
   (ii) The non-compliant event graph captures attacker's activities, which involves the execution of malicious operations that could result in non-compliant system states. Auditing results may be obtained (by applying existing security auditing tools and security controls covering different aspects of a network (e.g., a 5G network). The frequency of both compliant and non-compliant results may be measured for each security control to calculate the probability of a non-compliant result. The pre-condition (cause of the breach) and the post-condition (impact of the breach) for each non-compliant result may be determined using the description of the control (using MITRE frameworks). For each non-compliant control, its pre-condition and post-condition may be added as parent and child, respectively, allowing to correlate attacker's non-compliant state related activities with the network related activities. Further, non-compliant controls, and their pre-conditions and postconditions may be combined to build a state model, e.g., using model fusioner.
Graph Combinator (GC) 132: GC 132 may include modules such as a vertical combinator, a node connector, a horizontal connector, common node finder, etc. to facilitates the merging of two graphs: the normal event graph, and the non-compliant event graph. The final combined graph is fetched to the next module which is the posture calculator (PC) 134.
PC 134: This module uses the Bayesian Network inference to calculate the security posture based on the combined graph and may include a graph visualizer configured to render features of each graph.

Any of the modules and elements shown may be comprised within and/or be performed by NE security unit 32 and/or NE 16 or any other of its components.

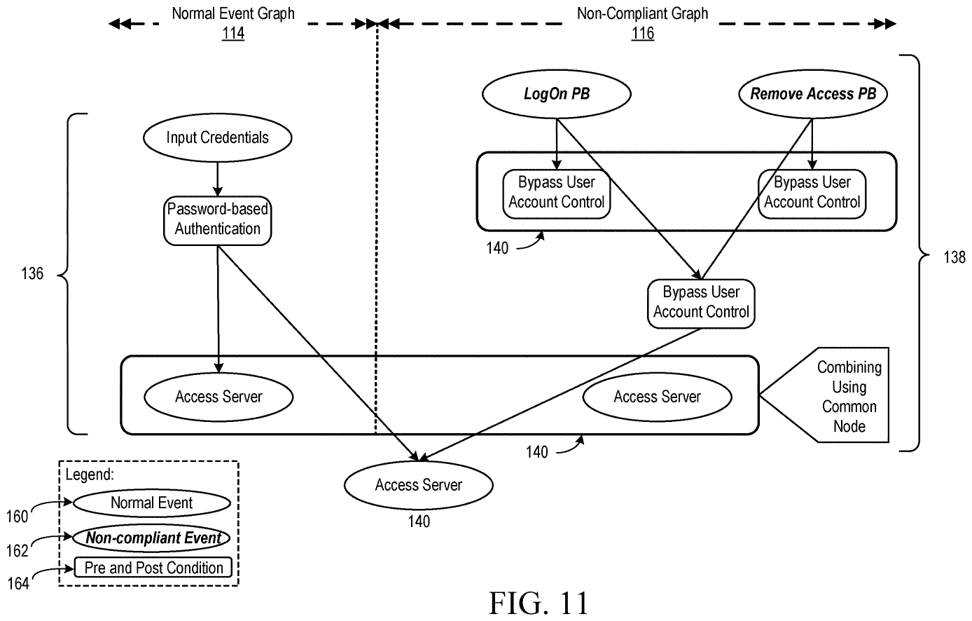

FIG. 11 shows an example horizontal graph combination of a normal event graph 114 and a non-compliant graph 116. More specifically, one or more normal events 160, one or more non-compliant events 162, and one or more pre and post conditions 164 are shown. Normal event graph 114 may include one or more nodes 136, and non-compliant graph 116 may include nodes 138. The combined effects of the attacker's activities causing non-compliance system states from the non-compliant graph and in-between breach activities supported by the network (e.g., 5G network) from the normal event graph 114 is shown. The common nodes 140 between both graphs caused by the impact of a privilege escalation resulting from a non-compliant system state are identified. For each common node 140 such as access server and/or bypass user account control, their parents and children from both graphs with their respective transition probabilities are recorded and/or merged (e.g., producing a merged list). The merged list may represent the steps an attacker may perform, whether by mimicking legitimate users or causing a breach, and captures the transition between these two. A new graph may be created by adding each common node to their parents and children. Finally, the remaining nodes (not added yet) from both original graphs may be added to the new final combined graph ..

The following is a nonlimiting example pseudocode for the horizontal combination:
1. Input: Normal Event Graph, Non-Compliant Graph;
2. Find and list all common nodes 140;
3. For each node in all common nodes 140:
   a. Find the parent nodes of that common nodes 140;
   b. Add all the parent nodes from both graph to the common nodes 140; and
4. Return combined graph.

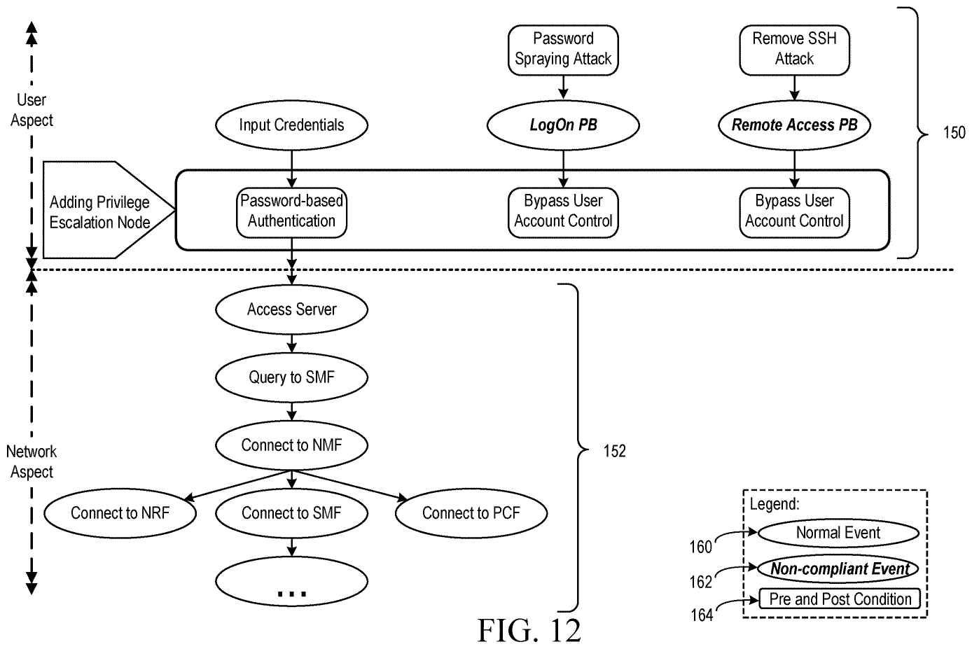

FIG. 12 shows an example vertical combination, which may include nodes 150 associated with a user aspect and nodes 152 associated with a network aspect. One or more normal events 160, one or more non-compliant events 162, and one or more pre and post conditions 164 are shown. A privilege escalation node may include password-based authentication, bypass user access control and bypass user account control. The vertical combination shows the impacts of a breach among different aspects (e.g., user, network) of a network. Privilege escalation (post-condition) that occurs as a result of a breach may be identified. Further, e.g., using the MITRE framework, the impact of this privilege escalation may be identified. The impact may be a legitimate event from the normal event graph or another breach of the system state from the non-compliant graph. Moreover, an expert may verify the decision using his/her understanding of attack and mitigation. In addition, the impacted node may be connected with the privilege escalation node to show the attacker's progress in different aspects.

The following is an example pseudocode for the horizontal combination:
1. Input: Normal Event Graph, Non-Compliant Graph;
2. Find and list all privilege escalation;
3. For each privilege escalation:
   a. Add a node to the graph;
   b. Connect the cause and effects node of that privilege escalation; and
4. Return combined graph.

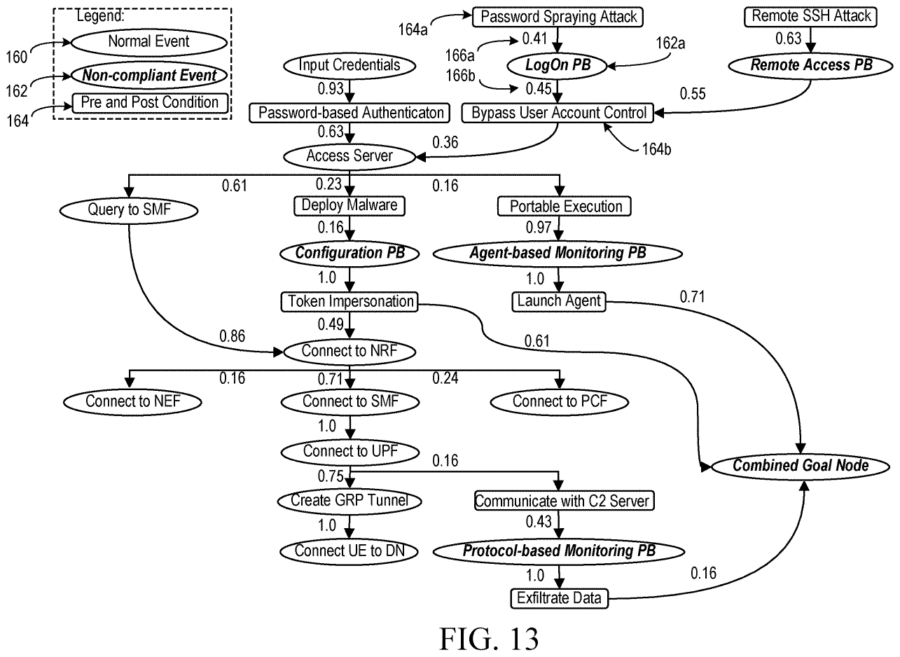

FIG. 13 shows an example combined graph where normal event graph and non-compliant graph are merged. This graph represents an example overall workflow of the system. To get a quantitative measurement, a Bayesian Network as a probabilistic tool may be used to calculate the conditional probability of the combined goal node (e.g., in a next step). The combined graph may include one or more normal events 160, one or more non-compliant events 162, and one or more pre and post conditions 164. Any one of the one or more normal events 160, one or more non-compliant events 162, and one or more pre and post conditions 164 may be referred to as nodes. A probability value 166 associated with two or more nodes may be determined. For example, a pre and post condition 164a (i.e., password spraying attack) may be associated with a non-compliant event 162a (i.e., LogOn PB), which may have a probability value 166a (i.e., 0.41). Similarly, noncompliant event 162a may be associated with pre and post condition 164b (i.e., bypass User Account Control), which may have a probability value 166b (i.e., 0.45). The overall conditional probability of noncompliant event 162n (i.e., combined goal node) may be determined based on the one or more normal events 160, one or more non-compliant events 162, one or more pre and post conditions 164, and or probability values 166.

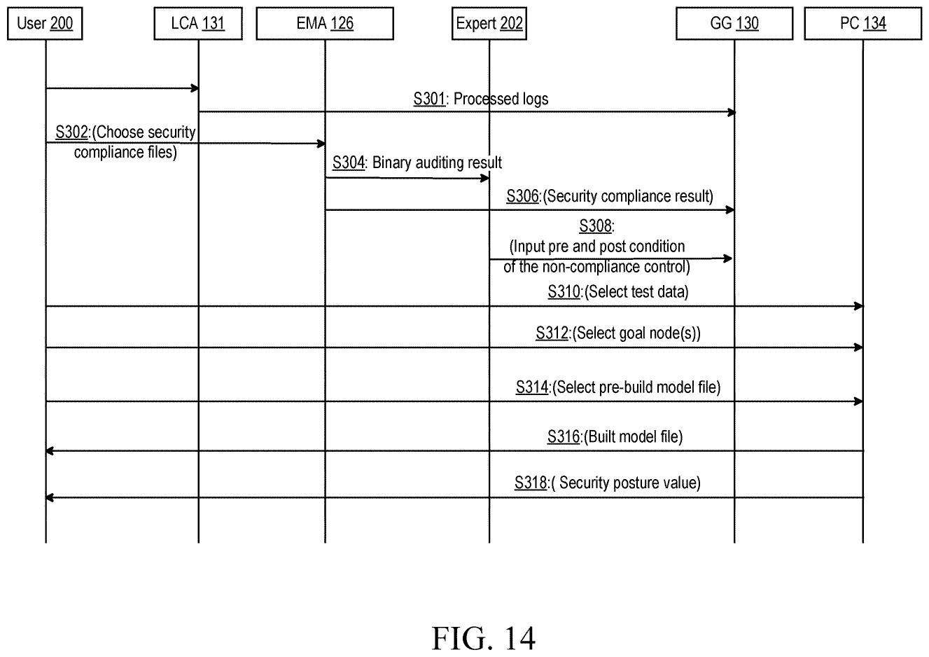

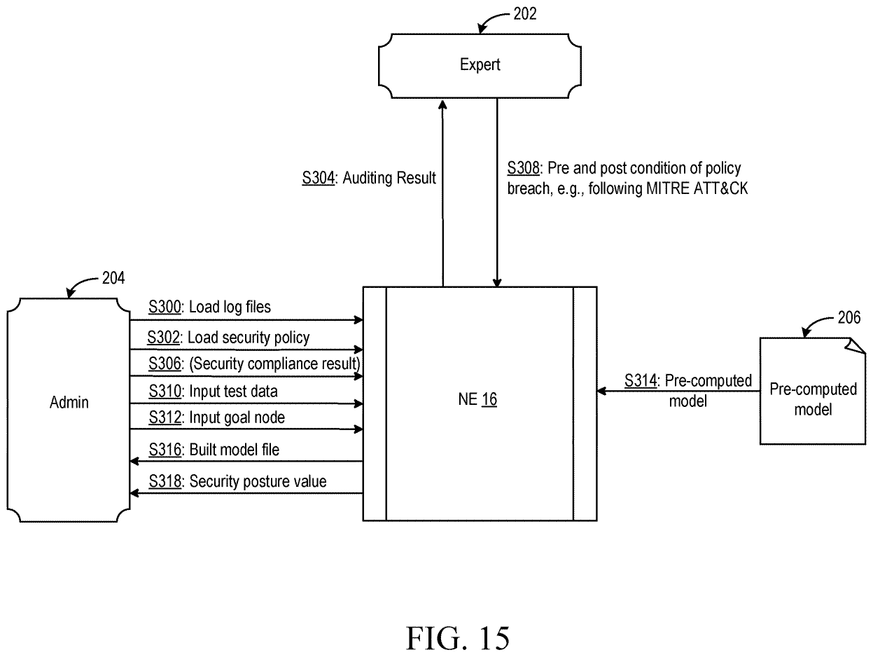

FIG. 14 is a sequence diagram showing an example process. At step S300, user 200 chooses log files which may be transmitted to LCA 131. At step S 301, processed logs may be transmitted to GG 130. At step S302, security compliance files may be transmitted to EMA 126. At step S304, binary auditing results may be transmitted to expert 202. At S306, EMA 126 transmits security compliance results to GG 130. At S308, input pre-condition and post-condition of the non-compliance control may be transmitted to GG 130. At step S310 test data is selected and transmitted to posture calculator 134. At step S312, goal node(s) are selected and/or transmitted to posture calculator 134. At step S314, a selected pre-build model file is transmitted to posture calculator 134. At step S316 a built model file is transmitted to user 200. At step S318, a security posture value is transmitted to user 200. In some embodiments, any of steps S300-S302 and S306-S314 may be an input to network element 16 (e.g., SePoCal) or its components and any of steps S304, S316, and S318 may be an output from network element 16 (e.g., SePoCal) or its components. The process may be described with respect to an interaction diagram as shown in FIG. 15 (showing example interactions with SePoCal of an administrator (admin) 204 and an expert (e.g., inputs and outputs of system 10, NE 16, etc.)). The administrator 204 may refer to the user 200 of FIG. 14. Any of the steps shown in FIG. 14 may include the features of the corresponding step in FIG. 15 and vice versa.

The administrator 204 may interact with NE 16 (e.g., SePoCal) as follows:
S300: The administrator 204 may load and/or choose log files. The administrator 204 may also specify the system log file and network log file. This may come from any existing monitoring system or the raw log file location.
S302: Administrator 204 may load security policy compliance files and/or specifies the location of the security policy file which comprises the defined security policy and respective source of auditing or monitoring that policy. An admin may have the rights to edit or change the policy.
S306: Administrator 204 may provide security compliance results. For example, the output from the security appliances (i.e., security compliance result) is used as the input in the graph generator.
S310: Administrator 204 can also simulate different situations based on the organization requirement and/or calculate overall posture value of the system, i.e., provide selected test data to NE 16
S312: Administrator 204 inputs/transmits the goal node (e.g., 162n in FIG. 13) for which the security posture is to be calculated. The goal node may be a critical node of the system which the administrator 204 may be most concerned about.
S316: the administrator 204 may receive a built model, e.g., in a file that NE 16 saved. The saved model (e.g., saved model file) may be used later such as to reuse, build, and/or rebuild the model without having to use the historical logs data again.
S318: The administrator 204 receives reports of security posture value for the system. The administrator 204 can use the report and/or other applications and/or improve or monitor the status of the system.

S314: A pre-computed model 206 may also be provided to NE 16. For example, instead of building the model from the scratch, the NE 16 can also use the existing model which is depicted by S310. Administrator 204 can specify the pre-computed model.

The expert 202 may input the precondition and postcondition of a policy breach and interact with NE 16 as follows:
S304: The expert 202 observes the auditing result (e.g., binary auditing result) corresponding to a specific security policy.
S308: The expert 202 provides the needed pre-condition and post-condition of the non-compliant security control.

In some embodiments, any of the steps performed by the user 200, expert 202 and administrator 204 may be automatically performed by NE 16 and/or any of its components. In some other embodiments, the expert 202 is a person that has the knowledge and experience to identify the pre-and post-conditions of a security event, for example, breaches. The administrator 204 may also be a person that seeks to find the security posture of the system by trying to interpret and correlate the results of different security monitoring tools. In some embodiments, interactions may be considered for initialization and/or operations. In some other embodiments, some interactions (e.g., S300, S302, S306, S312) may be used for initialization, while other steps are used for operative states.

In some embodiments, NE 16 may perform one or more actions based on the security posture value such as transmitting the security posture value to other components of system 10, e.g., components of trust evaluator 122 and/or SM 124, and/or cause trust evaluator 122 and/or SM 124 to perform additional actions such as security actions that may inform MANO or other components of the system 10 being protected.

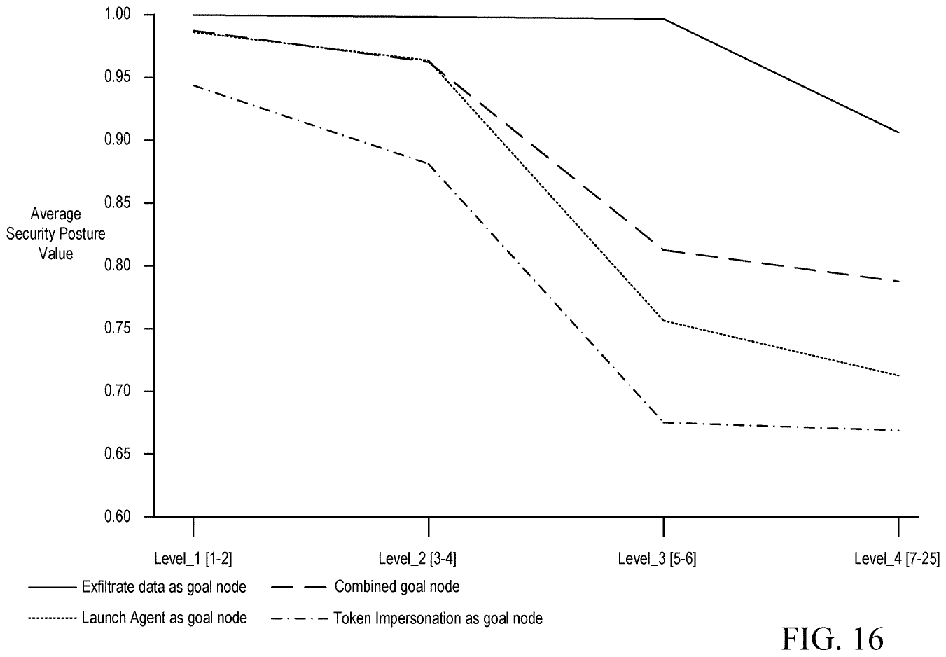

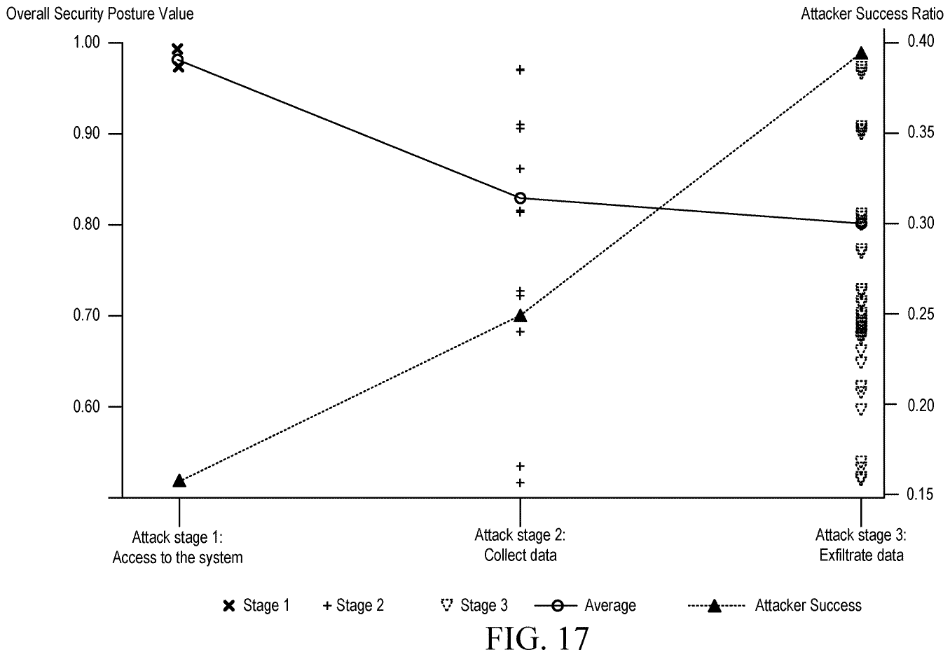

FIGS. 16 and 17 show example evaluation results associated with steps performed by network element 16, e.g., based on a real-life testbed implemented using free5Gc. More specifically, FIG. 15 shows an example impact of attacker capability on the system 10, i.e., average security posture value versus attacker capabilities (number of events) FIG. 16 shows an example impact of different attack stages, i.e., overall security posture value and attacker success ratio versus attack stages (combined goal node).

The following is a nonlimiting list of example embodiments.

Embodiment A1. A network element configured to, and/or comprising a communication interface and/or comprising processing circuitry configured to one or more of:
merge a normal event graph with a non-compliance graph to form a merged graph having one or more nodes;
determine a Bayesian Network (BN) based on the merged graph to calculate a conditional probability for each node of the merged graph;
determine a security posture based on the BN and the conditional probability; and perform one or more actions based on the security posture.

Embodiment A2. The network element of Embodiment A1, wherein the network element is configured to:
determine the normal event graph based on normal event data.

Embodiment A3. The network element of any one of Embodiments A1 and A2, wherein the network element is configured to:
determine the non-compliance graph based on security compliance information.

Embodiment A4. The network element of any one of Embodiments A1-A3, wherein the network element is configured to:
determine a goal node and a security state of the goal node using a BN inference to determine the security posture.

Embodiment B1. A method implemented in a network element, the method comprising one or more of:
merging a normal event graph with a non-compliance graph to form a merged graph having one or more nodes;
determining a Bayesian Network (BN) based on the merged graph to calculate a conditional probability for each node of the merged graph;
determining a security posture based on the BN and the conditional probability; and
performing one or more actions based on the security posture.

Embodiment B2. The method of Embodiment B1, wherein the method comprises:
determining the normal event graph based on normal event data.

Embodiment B3. The method of any one of Embodiment B1 and B2, wherein the method comprises:
determining the non-compliance graph based on security compliance information.

Embodiment B4. The method of any one of Embodiments B1-B3, wherein the method comprises:
determining a goal node and a security state of the goal node using a BN inference to determine the security posture.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network element configured to determine a security posture value associated with a system, the method comprising:
determining a normal event graph based at least on log data comprised in logs associated with a network;
determining a noncompliant graph based at least on breach event information;
generating a combined graph by combining the normal event graph with the noncompliant graph;
determining the security posture value associated with the system using the combined graph; and
performing one or more actions based on the security posture value.

2. The method of claim 1, wherein the generating of the combined graph includes:
performing a horizontal combination of the normal event graph and the noncompliant graph.

3. The method of claim 2, wherein the performing the horizontal combination includes one or more of:
determining one or more common nodes between the normal event graph and the noncompliant graph;
determining one or more parent nodes for each of the normal event graph and the noncompliant graph; and
for each common node of the one or more common nodes, merging the corresponding parent nodes from for each of the normal event graph and the noncompliant graph.

4. The method of claim 1, wherein the generating of the combined graph further includes:
performing a vertical combination of the normal event graph and the noncompliant graph.

5. The method of claim 4, wherein the performing of the vertical combination includes:
determining privilege escalation information based at least on the breach event information; and
adding the privilege escalation information to a node of the combined graph to generate a privilege escalation node.

6. The method of claim 5, wherein the performing of the vertical combination further includes:
determining an impact node associated with privilege escalation based on the privilege escalation information; and
connecting the impact node with the privilege escalation node to show a security attack progress.

7. The method of claim 1, wherein the determining of the security posture value includes:
building a Bayesian Network, BN, based on the combined graph.

8. The method of claim 7, wherein the determining of the security posture further includes:
identifying a goal node of the BN usable to determine the security posture, the goal node corresponding to a critical security event.

9. The method of claim 8, wherein the method further includes:
determining a conditional probability associated with the goal node based at least on one probability associated with other nodes of the combined graph, the conditional probability indicating a probability that an attacker may reach the goal node.

10. The method of claim 1, wherein the combined graph includes at least a normal event, a non-compliant event, a pre-condition associated with a breach event, and a post-condition associated with the breach event.

11. A network element configured to determine a security posture value associated with a system, the network element being configured to:
determine a normal event graph based at least on log data comprised in logs associated with a network;
determine a noncompliant graph based at least on breach event information;
generate a combined graph by combining the normal event graph with the noncompliant graph;
determine the security posture value associated with the system using the combined graph; and
perform one or more actions based on the security posture value.

12. The network element of claim 11, wherein the generating of the combined graph includes:
performing a horizontal combination of the normal event graph and the noncompliant graph.

13. The network element of claim 12, wherein the performing the horizontal combination includes one or more of:
determining one or more common nodes between the normal event graph and the noncompliant graph;
determining one or more parent nodes for each of the normal event graph and the noncompliant graph; and
for each common node of the one or more common nodes, merging the corresponding parent nodes from for each of the normal event graph and the noncompliant graph.

14. The network element of claim 11, wherein the generating of the combined graph further includes:
performing a vertical combination of the normal event graph and the noncompliant graph.

15. The network element of claim 14, wherein the performing of the vertical combination includes:
determining privilege escalation information based at least on the breach event information; and
adding the privilege escalation information to a node of the combined graph to generate a privilege escalation node.

16. The network element of claim 15, wherein the performing of the vertical combination further includes:
determining an impact node associated with privilege escalation based on the privilege escalation information; and
connecting the impact node with the privilege escalation node to show a security attack progress.

17. The network element of claim 11, wherein the determining of the security posture value includes:
building a Bayesian Network, BN, based on the combined graph.

18. The network element of claim 17, wherein the determining of the security posture further includes:
identifying a goal node of the BN usable to determine the security posture, the goal node corresponding to a critical security event.

19. The network element of claim 18, wherein the network element is further configured to:
determine a conditional probability associated with the goal node based at least on one probability associated with other nodes of the combined graph, the conditional probability indicating a probability that an attacker may reach the goal node.

20. The network element of claim 11, wherein the combined graph includes at least a normal event, a non-compliant event, a pre-condition associated with a breach event, and a post-condition associated with the breach event.
